(19) United States
(12) Patent Application Publication
(10) Pub. No.: US 2004/0107417 A1
(43) Pub. Date: Jun. 3, 2004

(54) Update network with support for lifecycle management of update packages and mobile handsets

(76) Inventors: Teck Chia, Aliso Viejo, CA (US); Bindu Rama Rao, Laguna Niguel, CA (US); Toni Pakarinen, Aliso Viejo, CA (US)

Correspondence Address: MCANDREWS HELD & MALLOY, LTD, 500 WEST MADISON STREET, SUITE 3400, CHICAGO, IL, 60661

(21) Appl. No.: 10/719,114

(22) Filed: Nov. 21, 2003

Related U.S. Application Data
(60) Provisional application No. 60/428,069, filed on Nov. 21, 2002.

(51) Int. Cl. G06F 9/44; G06F 9/445

(52) U.S. Cl. 717/171; 717/176

(57) ABSTRACT

An update network supports lifecycle management of update packages that are accessed by mobile handsets that are capable of updating its firmware/software employing an update agent. Specifically, a carrier network of the update network selectively disseminates update packages to mobile handsets employing a server that is capable of retrieving the update packages from an update store in the carrier network. The update network facilitates lifecycle management of update packages as well as the lifecycle management of mobile handsets.

### RELATED APPLICATIONS

This patent application makes reference to, claims priority to and claims benefit from U.S. Provisional Patent Application Serial No. 60/428,069, entitled “Update Network with Support for Lifecycle Management of Update Packages and Mobile Handsets,” filed on Nov. 21, 2002.

The complete subject matter of the above-referenced United States Provisional Patent Application is hereby incorporated herein by reference, in its entirety. In addition, this application makes reference to U.S. Provisional Patent Application Serial No. 60/373,422, entitled “Update Package Generation and Distribution Network,” filed Apr. 12, 2002, U.S. Provisional Patent Application Serial No. 60/249,606, entitled “System and Method for Updating and Distributing Information”, filed Nov. 17, 2000, and International Patent Application Publication No. WO 02/41147 A1, entitled “Systems And Methods For Updating And Distributing Information,” publication date Mar. 23, 2002, the complete subject matter of each of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. Updating firmware or firmware components can often be troublesome when changes and/or upgrades to the firmware or firmware components are required. Changes to firmware or firmware components must be performed in a fault tolerant mode and fault tolerant code are not easy to implement.

Typically, update packages containing the updating information for the firmware or firmware components in mobile handsets can be generated. However, managing the creation, dissemination, etc. of update packages is a complex activity that may span several years and may involve several systems. Similarly, mobile handsets may be used for several years, and their capabilities may be modified and/or enhanced by updating firmware/software. The management of such mobile handsets in terms of capabilities, services, etc. is again an important task that has not been adequately addressed by the industry.

Further limitations and disadvantages of conventional and traditional approaches will become apparent to one of ordinary skill in the art through comparison of such systems with the present invention.

### BRIEF SUMMARY OF THE INVENTION

Aspects of the present invention may be seen in a system that facilitates updating of firmware in an electronic device, wherein the system supports lifecycle management of firmware updating information. The system comprises an electronic device and a network that distributes the updating information to the electronic device. The electronic device comprises firmware, loading software that retrieves updating information for the firmware, and updating software that applies the retrieved updating information to the firmware in the electronic device. The network comprises updating storage that stores updating information to be distributed to the electronic device, and at least one server that retrieves the updating information from the updating storage.

In one embodiment of the present invention, the at least one server distributes the retrieved updating information to the electronic device. In another embodiment of the present invention, the at least one server further supports management of the lifecycle of the updating information and supports management of the lifecycle of the electronic device.

In an embodiment of the present invention, the network may also comprise a first structure that manages the lifecycle of the electronic device, and a second structure that manages the lifecycle of the updating information associated with the electronic device. In such an embodiment, the first structure may track changes of firmware versions in the electronic device, provide information about available firmware updates to the electronic device, and interact with the at least one server to provide information about firmware updates. In the same embodiment, the second structure may support import updating information from an updating information file containing updating information for different version changes of firmware, and verify the authenticity of firmware updating information.

Aspects of the present invention also provide a method for updating firmware in an electronic device of a system that supports lifecycle management of firmware updating information, where the system comprises the electronic device and a network. The method may comprise generating updating information in a generation environment, saving the generated updating information in a storage unit, communicating the saved updating information to a distribution environment, and managing the lifecycle of the updating information.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary update network with support for lifecycle management of update packages and mobile handsets, in accordance with an embodiment of the present invention.

FIG. 2 illustrates a block diagram of an exemplary carrier network, in accordance with an embodiment of the present invention.

FIG. 3 illustrates an exemplary high-level system components and where they may exist in the system environment in relation to each other, in accordance with an embodiment of the present invention.

FIG. 4 illustrates an exemplary way of how the three components of MVC may work together, in accordance with an embodiment of the present invention.

FIG. 5 illustrates an exemplary site map of the web management console, in accordance with an embodiment of the present invention.

FIG. 6 illustrates an exemplary JMX system, in accordance with an embodiment of the present invention.

FIG. 7 illustrates an exemplary Update Package Store GUI structure, in accordance with an embodiment of the present invention.

FIG. 8 illustrates an exemplary method of addition of a new carrier, in accordance with an embodiment of the present invention.

FIG. 9 illustrates an exemplary method of deletion of existing carriers, in accordance with an embodiment of the present invention.

FIG. 10 illustrates an exemplary method of editing existing carriers, in accordance with an embodiment of the present invention.

FIG. 11 illustrates an exemplary method of addition of a new device manufacturer, in accordance with an embodiment of the present invention.

FIG. 12 illustrates an exemplary method for deletion of existing device manufacturer, in accordance with an embodiment of the present invention.

FIG. 13 illustrates an exemplary method for editing of existing device manufacturer, in accordance with an embodiment of the present invention.

FIG. 14 illustrates an exemplary method for addition of a new client device model, in accordance with an embodiment of the present invention.

FIG. 15 illustrates an exemplary method for deletion of existing client device model, in accordance with an embodiment of the present invention.

FIG. 16 illustrates an exemplary method for editing of existing client device model, in accordance with an embodiment of the present invention.

FIG. 17 illustrates an exemplary method for uploading of an update package, in accordance with an embodiment of the present invention.

FIG. 18 illustrates an exemplary method for deletion of an update package, in accordance with an embodiment of the present invention.

FIG. 19 illustrates an exemplary method for searching for an update package, in accordance with an embodiment of the present invention.

FIG. 20 illustrates an exemplary method of changing an update package state, in accordance with an embodiment of the present invention.

FIG. 21 illustrates an exemplary method of creating new roles, in accordance with an embodiment of the present invention.

FIG. 22 illustrates an exemplary method of editing existing roles, in accordance with an embodiment of the present invention.

FIG. 23 illustrates an exemplary method for deletion of an existing role, in accordance with an embodiment of the present invention.

FIG. 24 illustrates an exemplary method for creation of a new administrator account, in accordance with an embodiment of the present invention.

FIG. 25 illustrates an exemplary method for deletion of an existing administrator account, in accordance with an embodiment of the present invention.

FIG. 26 illustrates an exemplary method for modification to an existing administrator account, in accordance with an embodiment of the present invention.

FIG. 27 illustrates an exemplary method for display of a provisioned device server(s), in accordance with an embodiment of the present invention.

FIG. 28 illustrates an exemplary method for provisioning of new device servers, in accordance with an embodiment of the present invention.

FIG. 29 illustrates an exemplary method for enabling/disabling device servers, in accordance with an embodiment of the present invention.

FIG. 30 illustrates an exemplary method for configuring of device servers, in accordance with an embodiment of the present invention.

FIG. 31 illustrates an exemplary method for enabling/disabling of update store, in accordance with an embodiment of the present invention.

FIG. 32 illustrates an exemplary method for time zone configuration in the system, in accordance with an embodiment of the present invention.

FIG. 33 illustrates an exemplary method for display of active, acknowledged, and all alarms, in accordance with an embodiment of the present invention.

FIG. 34 illustrates an exemplary method for change of alarm status, in accordance with an embodiment of the present invention.

FIG. 35 illustrates an exemplary method for displaying the activities logs, in accordance with an embodiment of the present invention.

FIG. 36 illustrates an exemplary method for log retrieval for analysis, in accordance with an embodiment of the present invention.

FIG. 37 illustrates an exemplary method for the LicenseKeyAction Servlet, in accordance with an embodiment of the present invention.

### DETAILED DESCRIPTION OF THE INVENTION

The present invention relates generally to the process of updating software/firmware in electronic devices, and, more specifically, to the lifecycle management of the update packages (updating information for firmware/software updates) and of the mobile handsets.

Although the following discusses aspects of the invention in terms of a mobile handset, it should be clear that the following discussion also applies to other mobile electronic devices such as, for example, personal digital assistants (PDA's), pagers, personal computers (PCs), and similar handheld electronic devices.

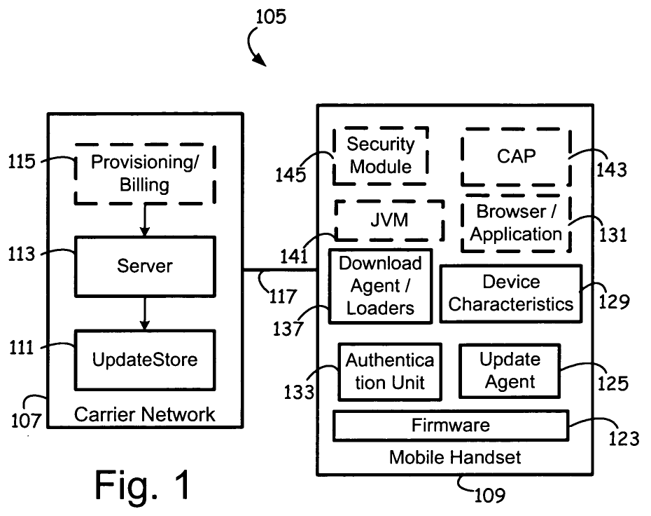

FIG. 1 illustrates an exemplary block diagram of an update network 105 with support for lifecycle management of update packages and mobile handsets 109, in accordance with an embodiment of the present invention. The update network 105 may comprise a mobile handset 109 and a carrier network 107.

Lifecycle management of an update package may comprise actions such as, for example, creating, deleting, and editing of update packages. Lifecycle management of update packages may also comprise changing status information such as, for example, information specifying who gets an update package, or when to start dispensing an update package.

Lifecycle management on a mobile handset may comprise, for example, provisioning of the mobile handset, determining change of mobile handset ownership, determining change of mobile handset subscription, or determining that a mobile handset is no longer used in a network.

Administrators may be utilized in lifecycle management of the update packages and of the mobile handsets. Administrators may be capable of, in lifecycle management of update packages for example, editing status information regarding update packages or mobile handsets.

In an embodiment of the present invention, the carrier network 107 may comprise an update store 111 and a server 113. In an embodiment of the present invention, the carrier network 107 may also comprise provisioning/billing software 115. In an embodiment of the present invention, the carrier network 107 may be capable of distributing update packages to the mobile handset 109 employing the server 113. The server 113 may be capable of retrieving the update packages from the update store 107 in the carrier network 107.

In an embodiment of the present invention, the mobile handset 109 may comprise firmware 123, an update agent 125, an authentication unit 133, device characteristics 129, and a download agent/loader 137. In an embodiment of the present invention, the mobile handset 109 may also comprise a java virtual machine (JVM) 141. In another embodiment of the present invention, the mobile handset 109 may also comprise a browser/application 131. In yet another embodiment of the present invention, the mobile handset 109 may also comprise a security module 145. In still another embodiment of the present invention, the mobile handset 109 may also comprise a component architecture platform module 143.

In an embodiment of the present invention, the mobile handset 109 may be capable of updating its firmware/software employing the update agent 125. In an embodiment of the present invention, the mobile handset 109 may employ the download agent/loader 137 to download update packages to fix the software errors or bugs that cause errors or exceptions. The mobile handset 109 may employ the update agent 125 to update the firmware/software in the mobile handset 109. In an embodiment of the present invention, the download agent/loader 137 may employ device characteristics 129 to retrieve update packages from the carrier network 107.

In an embodiment of the present invention, the update store 111 may be used as a repository of update packages that are to be distributed to mobile handsets 109. The mobile handsets 109 may send queries such as, for example, extensible markup language (XML) queries. The queries may include information such as, for example, a manufacturer, model identifier, and version identifier information, to retrieve an update package. The server 113 may interact with the mobile handset 109 to receive queries, process them, and may retrieve one or more update packages from the update store 111 based on the query received. The server 113 may pass the retrieved update packages back to the mobile handset 109.

In an embodiment of the present invention, the update store 111 may support the management of the lifecycle of update packages. In another embodiment of the present invention, the update store 111 may support the management of the lifecycle of update packages as well as the lifecycle of mobile handsets 109.

In an embodiment of the present invention, an end-to-end process of a firmware/software update solution may comprise generating one or more update packages within a generation environment. The generation environment may be provided by the carrier network 107 or by a manufacturer. In an embodiment of the present invention, the process may also comprise saving the generated update packages in a repository along with associated metadata information such as, for example, identification information, security information, operation information, configuration information, etc. The process may comprise packaging one or more generated update packages, associated metadata, and optional security information into a deliverable unit such as, for example an update package file. In addition, the process may comprise communicating the deliverable unit to a testing environment in the carrier network 107, and/or to a distribution environment, also in the carrier network 107, comprising the update store 111 and the server 113. The process may also comprise populating the update store 111 with update packages, employing a lifecycle management system for update packages. An embodiment of the present invention may manage the lifecycle of update packages in the carrier network 107, receive requests for update packages, determine appropriate protocol handlers and employ them, and facilitate downloads of update packages by end-user mobile handsets 109. In an embodiment of the present invention, the process may also comprise scheduling of downloads by end-users and/or notification of mobile-device end-users. The process may also comprise download activities initiated by end-user on mobile handsets 109, verification of received update packages by the download agent/loader 137 in the mobile handsets 109, implementation of update package instructions by an update agent 125 in the mobile handset 109, and verification of the effectiveness of the update activity in the mobile handset 109. In an embodiment of the present invention, the process may also comprise creating and storing billing information for processing and/or tracking of downloads by end-user mobile handsets 109.

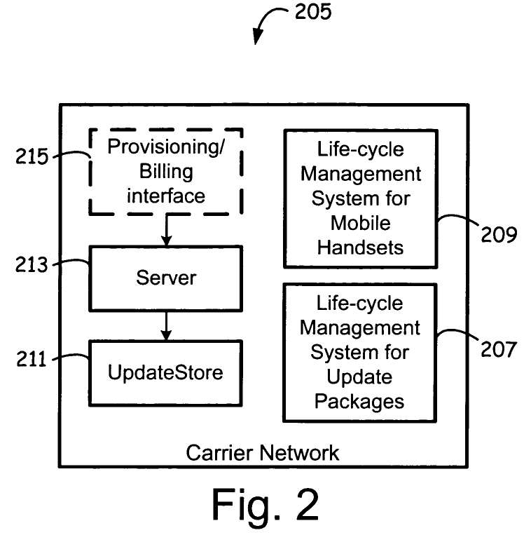

FIG. 2 illustrates an exemplary block diagram of a carrier network 205, in accordance with an embodiment of the present invention. In an embodiment of the present invention, the carrier network 205 may comprise a life-cycle management system for mobile handsets 209 and a lifecycle management system for update packages 207, which together may be employed to manage the lifecycles of both mobile handsets and their associated update packages. The carrier network 205 may also comprise a server 213, and an update store 211 that serves as a repository of all update packages whose lifecycle may be managed by the lifecycle management system for update packages 207. In an embodiment of the present invention, the carrier network 205 may also comprise a provisioning/billing interface 215, which may serve as an interface to systems that support provisioning of mobile handsets for subscribers while facilitating billing features. In an embodiment of the present invention, the update store 211 may also serve as a repository for all data managed by the lifecycle management system for mobile handsets 209.

In an embodiment of the present invention, the lifecycle management system for mobile handsets 209 may involve several activities such as, for example, tracking version changes of firmware and software in mobile handset models, providing information on available upgrades for firmware and software to various mobile handset families, providing information on different service levels and their availability on different makes/models of mobile handsets, and working with a provisioning server to provide information about possible upgrades.

In an embodiment of the present invention, the lifecycle management of mobile handsets module 209 may provide a powerful and intuitive configuration specification/maintenance user interface, the capability to store configuration information for mobile handsets within a shared database, and/or, a complete toolset for specifying and manipulating complex, deep and wide hierarchical versioning structures.

In an embodiment of the present invention, the lifecycle management system for update packages 207 may support importing update packages from an update package file containing update packages for different version changes of firmware/software for a given make/model of a mobile handset. Update package files that contain update packages for more than one make/model of mobile handsets from a single manufacturer may also be supported. In an embodiment of the present invention, the update package file containing update packages may be an XML file with encrypted update packages; each update package may be provided with its own metadata. In such an embodiment, the lifecycle management system for update packages 207 may be the only system capable of decrypting the encrypted XML file.

In an embodiment of the present invention, the authenticity of uploaded update packages may be verified by the lifecycle management system for update packages 207. A new update package object may be instantiated in the update store following a successful upload and verification of an update package by the lifecycle management system for update packages 207 from an update package file, or from an alternate mechanism.

In an embodiment of the present invention, a generator tool in a generation environment provided by a manufacturer, for example, may create the update package file. The manufacturer may generate update packages, may create metadata for each update package, and may associate the two together when they are loaded into an update package file that can support multiple update packages. In an embodiment of the present invention, the metadata may comprise a name, a model, version information, cyclic redundancy check (CRC) value, size information, starting addresses, optional ending addresses, etc. In an embodiment of the present invention, the CRC value may be employed by the mobile handset that receives an update package to verify the authenticity of the update package. Thus, the CRC value may be employed by a consumer of an update package such as, for example, a mobile handset 109 of FIG. 1, to authenticate an update package (or other data) sent by a producer of the update package, completely independent of any distribution mechanisms and data transport protocols, etc.

In an embodiment of the present invention, a system supporting lifecycle management features may include a web management console, components to support functionalities of the management console and simple network management protocol (SNMP) support for alarms. SNMP is a set of specifications that standardize the way hardware and software processes are managed and monitored over a network.

The management interface module of the server associated with the management interface module may provide a web-based hypertext markup language (HTML) management console to allow an administrator to manage update packages and administer the system, and support for SNMP configuration, monitoring and alarm alerts.

The components of the management interface may exist mainly within the update store system. The components of the management interface may consist of the web application components, the management-related objects and SNMP components. At the device server, a thin management interface layer may be used to push alarms and to receive configuration changes. However, the web-based and SNMP management console used by the administrator may only interact with the update store.

FIG. 3 illustrates an exemplary high-level system components and where they may exist in the system environment in relation to each other, in accordance with an embodiment of the present invention. The HTML management console may be built and deployed on a platform standard for multi-tier application such as, for example, the J2EE platform (Sun's Java platform standard for multi-tier applications). The HTML console pages may be generated dynamically using tools such as, for example, a combination of JavaServer Pages (JSP), which is a dynamic page generation specification from Sun, Servlets (Java server-side code that processes requests, most widely used for hyper text transfer protocol (HTTP) requests, analogous to common gateway interface (CGI) programs), and JavaBeans that adhere to the model-view-controller (MVC) design pattern.

A widely used MVC framework may be used. An advantage of the MVC pattern and MVC implementation may be the decoupling of functionally disparate components so that extensibility or modifications may be achieved without a lot of dependencies between the components. The MVC design pattern allows components of a web application to be more modular and reusable. The MVC pattern encapsulates three main abstractions: model, view, and controller. These abstractions enable MVC to separate presentation logic from the business logic of a web application.

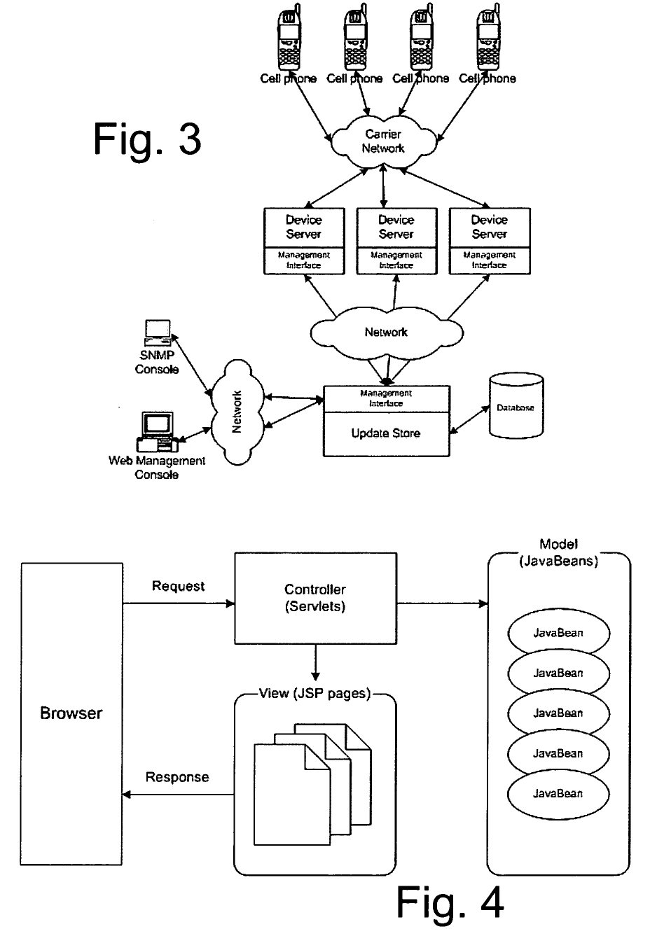

FIG. 4 illustrates an exemplary way of how the three components of MVC may work together, in accordance with an embodiment of the present invention. The controller components may be responsible for fielding requests from clients, determining which action Servlets may be able to handle the request, and responding to the clients with the appropriate JSP page. Each action Servlet may call upon appropriate JavaBeans to perform tasks and then forward an appropriate JSP page back to the client.

The model components may be JavaBeans that encapsulate the business logic and objects of the application. The JavaBeans may be reused in different contexts because they do not have web-specific implementation in them.

The view components may be mainly JSP pages along with custom JSP tags that may be responsible for generating presentation pages back to the client. The JSP pages may control the format and location of data on the page, but not how the data is generated. Any changes in the controller or model components will have minimal impact on the view components.

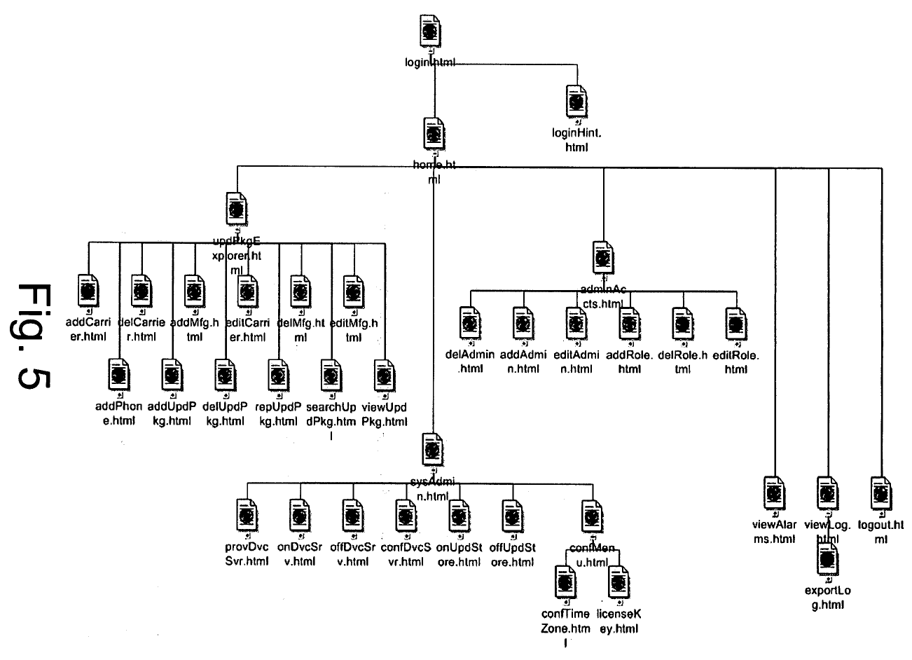

FIG. 5 illustrates an exemplary site map of the web management console, in accordance with an embodiment of the present invention. The files in the tree map may be JSP pages that may be presented to the user. The file suffix .html may not necessarily mean that the pages are not dynamically generated using JSP. The online help pages and a generic error page are not shown on the site map because every page has a link to them.

Online help may comprise a mini-site with a table of contents and a set of sections relating to the management console. A user may be able to browse through the entire help site using next and previous links, as well as with the table of contents.

Online help may be context-based, meaning that clicking on the help button may bring up a certain section or page of help based on where the user may be on the site. There may be a simple mapping between where the user is and which help page to bring up. The help page may be displayed on a new mini-browser window. The table below shows exemplary mapping between where the user may be on the site and which help page to bring up. On each help page, there may be navigational links enabling a user to go to the next/previous page and to the table of contents.

| User Location | Help sections |
|---|---|
| Home page and Error page. | Table of contents |
| Any page within update package | Update Package Management |
| management. | |
| Any page within update package | System Administration |
| management. | |
| Any page within administrator | Administrator Account Management |
| account management. | |
| Any page within Alarms. | Alarms |
| Any page within Activity Log. | Activity Log |
| | FAQ |
| | Troubleshooting Tips |
| | Resources (links to any docs) |
| | Support |

When an action Servlet encounters an error, it may forward the response to an error page. The system-generated exception message may be caught and logged, and a user-friendly message may be displayed back to the user on the error page, with a link back to the previous page.

The following classes may be useful to represent the entities in the management interface module. These classes encapsulate the system/business logic behind the management interface and may be used by the action Servlets (controller components) to process requests from the client.

The Administrator object may represent the administrator of the system. The object may store attributes of an administrator and may be used for access authentication and access control to update packages via the Role object.

public Administrator( );//default constructor

public Administrator(String userID, String password, String firstName, String lastName, Role role);//constructor that initializes the required parameters.

public void setUserID(String userID);//settor method for the unique user ID of the administrator.

public String getUserID( );//accessor method for the unique user ID of the administrator.

public void setFirstName(String firstName);//settor method for the first name of the administrator.

public String getFirstName( );//accessor method for the first name of the administrator.

public void setLastName(String firstName);//settor method for the last name of the administrator.

public String getLastName( );//accessor method for the last name of the administrator.

public void setPassword(String password);//settor method for the password of the administrator.

public boolean matchPassword(String password);//match the passed-in password with the password stored in the database.

public void setEmail(String email);//settor method for the email address of the administrator

public String getEmail( ); accessor method for the email address of the administrator

public void setPhoneNumber(String phone);//settor method for the phone number of the administrator

public String getPhoneNumber( );//accessor method for the phone number of the administrator

public void setMobileNumber(String mobile);//settor method for the mobile number of the administrator.

public String getMobileNumber( );//accessor method for the mobile number of the administrator.

public void setDescription(String desc);//settor method for a description of the administrator.

public String getDescription( );//accessor method for the description of the administrator

public void setRole(Role role);//settor method for the role of the administrator

public Role getRole( ); 11 accessor method for the role of the administrator.

public Date getCreationDate( ); 11 accessor method for the date of account creation.

public void setAccountStatus(int status);//settor method for the status of the admin account

(active or deleted). An account is never removed and a super administrator will be able to see deleted accounts.

public int getAccountStatus( );//accessor method for the constant value that represents the status of the admin account. (active or deleted).

public boolean isSuperAdministrator( );//returns true if super administrator, else false.

The Role object may encapsulate the access control information stored in an administrator role. The default access permission may be Read and Write permissible for each new folder for all roles until specified otherwise by the super administrator.

public Role( );//default constructor

public Role(String name);//constructor that takes in a unique role name.

public void setName(String roleName);//settor method for the unique name of the role.

public String getName( );//accessor method for the unique name of the role.

public void setPermission(Object o, int permission);//sets the permission for an object (Carrier, Manufacturer, Model) to R or W for this role.

public int getPermission(Object o);//returns the permission (R,W) for an object.

public void setStatus(int status);//settor method for the status of the role. (active/deleted).

public int getStatus( );//accessor method for the status of the role.

The AdministratorAccounts object is a class that may contain utility methods for creating, deleting and manipulating Administrator and Role objects.

public AdministratorAccounts( ); default constructor will instantiate all Administrator objects.

public void updateAdministrator(Administrator a); update an administrator and persist it to the database.

public void addAdministrator(Administrator a); add a new administrator and add it to the database.

public Admininistrator getAdministrator(String userID); returns the administrator with the user ID.

public void deleteAdministrator(String userID); deletes the administrator with the user ID.

public void deleteAdministrator(String[ ] userID); deletes administrators with the list of user IDs in the array.

public Administrator[ ] getAllAdministrators( ); returns an array of all administrators.

public Role getRole(String roleName); returns the role with the name.

public Role[ ] getRoles( ); returns all roles.

public void addRole(Role r); add a new role and add it to the database.

public void updateRole(Role r); update an existing role and persist it to the database.

public void deleteRole(String roleName); deletes the role with the name.

public void deleteRole(String[ ] roleNames); deletes roles with names in the array.

The SystemConfiguration object may encapsulate the system configuration and the effects of configuring the system with different values. This object may be used by the Servlet fielding requests from the System Administration screens of the HTML management console.

public SystemConfiguration( );//default constructor

public void addDeviceServer(DeviceServer ds); adds a new device server to the provisioned list.

public DeviceServer getDeviceServer(String name); returns a device server with the given name.

public DeviceServer[ ] getAllDeviceServers( ); returns an array of provisioned device servers.

public UpdateStore getUpdateStore( ); returns the update store object representing the update store configuration.

public void setTimeZone(int timezone); sets the time zone for display of time and date.

public int getTimeZone( ); accessor method for the time zone for displays.

The DeviceServer object may encapsulate the configuration of a device server and the behavior of a configuration change. This object may be used by the Servlet fielding requests from the System Administration screens of the HTML management console.

public DeviceServer( );//default constructor

public DeviceServer(String serverName, InetAddress hostaddress, int status);//constructor that takes in values that are mandatory for a new Device Server.

public void setName( ); settor method for the name of the device server.

public String getName( ); accessor method for the name of the device server.

public void setHostAddress(InetAddress ip); settor method for the host IP address of the device server.

public InetAddress getHostAddress( ); accessor method for the host IP address of the device server.

public void setDescriptiono; settor method for the description for the device server.

public String getDescription( ); accessor method for the description for the device server.

public void setStatus(int status); settor for the status of the device server (enabled, disabled). This method will trigger the start or halt of the device server service.

public int getStatus( ); accessor method for the status of the device server.

public Date getProvisionDate( ); accessor method for the date when the device server was provisioned.

The UpdateStore object may encapsulate the configuration of the update store where the management components may be located and the behavior of a configuration change. This object may be used by the Servlet fielding requests from the System Administration screens of the HTML management console.

public UpdateStore( );//default constructor.

void setStatus(int status); settor for the status of the update store (enabled, disabled). This method will trigger the start or halt of the update store service.

public int getStatus( ); accessor method for the status of the update store.

The AlarmLog object may encapsulate the alarms log and the methods to retrieve and manipulate alarms. This object may be used by the Servlet fielding requests from the Alarms screens of the HTML management console.

public AlarmsLog( );//default constructor

public void addAlarm(Alarm a);//add an alarm entry to the log.

public Alarm[ ] getalarns( );//returns all alarms in the log.

public Alarm[ ] getAlarms(Date start, Date end);//returns all alarms between start and end dates.

public Alarm[ ] getActiveAlarms( );//returns all active alarms in the log.

public Alarm[ ] getActiveAlarms(Date start, Date end);//returns all active alarms between start and end dates.

public Alarm[ ] getAcknowledgedAlarms( );//returns all acknowledged alarms in the log.

public Alarm[ ] getAcknowledgedAlanns(Date start, Date end);//returns all acknowledged alarms between start and end dates

public Date getLastAlarmDate( ); 11 returns the date of last alarm generated

public Alarm[ ] sortAlarms(Alarm[ ], int sortAttribute, int direction);//sorts an array of Alarm objects based on a Alarm attribute and direction (ascending/descending).

The Alarm object may encapsulate the notion of an alarm in the system. This object may be used by Servlets handling requests from the Alarms screens of the HTML management console.

public Alarm( );//default constructor

public Alarm(String alarmID, Date time Stamp, String alarmCode, InetAddress host, int status, int severity);//constructor that initializes the mandatory parameters.

public void setID(String id);//sets the unique ID of the alarm.

public String getID( ); 11 returns the unique ID of the alarm.

public void setTimeStamp(Date date);//sets the timestamp of the alarm.

public Date getTimeStamp( );//returns the timestamp of the alarm.

public void setCode( );//sets the alarm code that identifies type of alarm.

public String getCode( );//returns the alarm code that identifies type of alarm.

public void setHost(InetAddress host);//sets the host IP address where the alarm is generated.

public InetAddress getHost( );//returns the host IP address where the alarm is generated.

public void setStatus(int status);//sets the status of the alarm (active, inactive, acknowledged).

public int getStatus( );//returns the status of the alarm.

public void setSeverity(int sev);/sets the severity of the alarm (1-4).

public int getSeverity( );//returns the severity of the alarm.

public int getRepeatCount( );//returns the number of repeated alarms generated.

public void setDescription(String desc);//sets the description of the alarm.

public String getDescription( );//returns the description of the alarm.

The ActivityLog object may encapsulate the activity log. It may contain methods to retrieve and manipulate arrays of activities.

public ActivityLog( );//default constructor

public void addActivity(Activity a);//add an activity to the log.

public Activity[ ] getActivities(Date start);//returns all activities in the log from a certain date to latest.

public Activity[ ] getActivities(Date end);//returns all activities in the log from earliest to a certain date.

public Activity[ ] getActivities(Date start, Date end);//returns all activities in the log between start and end dates.

public Activity[ ] getActivities(int sortOrder, int sortParameter, Date start, Date end);//returns activities between start and end dates sorted by a certain parameter, either ascending or descending.

public String exportActivities(Date start, Date end);//returns an XML formatted string containing log entries between start and end dates.

The Activity object may encapsulate an activity in the system.

public Activity( );//default constructor

public Activity(Date timeStamp, String activitycode, String description);//constructor that initializes mandatory parameters.

public void setTimeStamp(Date date);//sets the time stamp of the activity.

public Date getTimeStamp( ); returns the time stamp of the activity.

public void setCode(String code);//sets the activity code.

public String getCode( );//returns the activity code.

public void setStatus(int status);//sets the activity status. (success, failed)

public int getStatus( );//returns the activity status.

public void setUpdPkg(String name);//sets the update package name if the activity is update package related.

public String getUpdPkg( );//returns the update package name if the activity is update package related.

public void setDescription(String desc);//sets the activity description.

public String getDescription( );//returns the activity description.

The LicenseKey object may encapsulate a license key that enables the system.

public LicenseKey( ); default constructor

public LicenseKey(String key); constructor that initializes the key string.

public void setKey(String key);//sets the license key.

public String getKey( );//returns the license key.

public int getLimit( );//returns the transaction limit for this key.

public Date getExpirationDate( );//returns the expiration date of the key.

public int getStatus( );//returns the status of the key. (valid, invalid)

The LicenseMonitor object may be a utility class that contains methods to monitor license thresholds and compliance.

public LicenseMonitor( );//default constructor

public int getNumTransactions( );//returns the number of update transactions recorded.

public int getNumTransactions(Date start, Date end);//returns the number of update transactions recorded between start and end dates.

public void reset( );//resets the counter.

SNMP support may be provided via tools for managing Java components such as, for example, the Java Management Extensions (JMX) design pattern specified by Sun Microsystems, Inc. JMX may specify a framework for managing Java components and applications. The framework may decouple the applications to be managed from the exposed management interfaces and protocols (e.g. SNMP) used by management consoles.

Several vendors such as, for example, AdventNet, Inc., IBM Corporation, and Tivoli Systems, may implement JMX. AdventNet, Inc., for example, provides a JMX toolkit that includes a MIB Editor, a JMX Compiler that generates JMX stub code, and a protocol adaptor for SNMP.

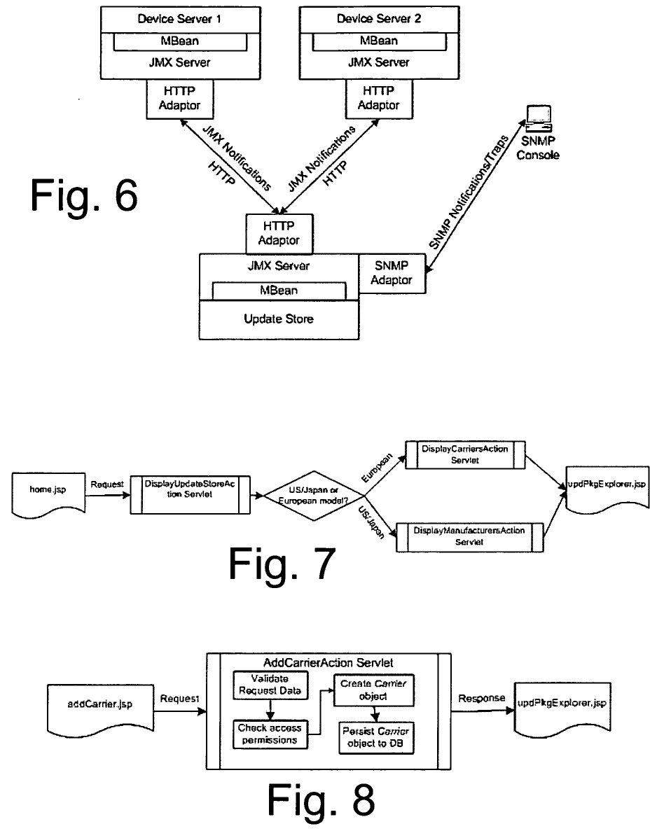

FIG. 6 illustrates an exemplary JMX system, in accordance with an embodiment of the present invention. At each Device Server and Update Store node, there may be JMX servers (also known as agents or MBeanServer) hosting MBeans, which may expose management interfaces of their respective resource. JMX Servers may host MBean implementations and provide services such as notifications and protocol adaptors.

The JMX Server at the Update Store may serve as the Master Agent, and the JMX Servers at each Device Server may serve as Slave Agents. The Master Agent may, as a result, have handles to the MBeans hosted by Slave Agents at the Device Servers. Slave agents may be discovered by the Master Agent, and the Master Agent may communicate with the Slave agents via HTTP. This architecture allows the system to have one logical point of management and allows for third-party management console or applications to talk to only one agent for the entire application.

A management information base (MIB) editor such as, for example, the MIB Editor from AdventNet, Inc., may be used as a tool to define the private MIB. The MIB is a part of SNMP that may refer to a collection of managed objects residing in a virtual information store. The MIB editor may enable the definition of a MIB using an easy-to-use graphical user interface (GUI) and may ensure that the MIB definition complies with the structure of management information (SMI) syntax. The SMI may be a part of SNMP that refers to the structure and syntax used for describing and naming objects. The specific notification types (otherwise known as trap types in SNMP) may be defined in the MIB.

From the MIB, MBean interface stubs may be generated using a JMX compiler such as, for example, the JMX compiler from AdventNet, Inc. Implementing the MBean interfaces may instrument the managed resources in the system.

In this system, Mbeans are the interfaces that a resource to be managed would implement. The interfaces represent the properties that may be read or configured for that resource. MBean implementations may also generate JMX notifications and/or SNMP notifications for alarm events.

A DeviceServerMBean interface may be implemented by the DeviceServer object to expose interfaces that a SNMP management console can use to query or set configuration parameters.

public void setName(String name);//sets the device server name.

public String getName( );//returns device server name.

public void setHost(InetAddress ip);//sets the device server host location.

public InetAddress getHost( );//returns the device server host location's IP address.

public void setPort(String portNumber);//sets the server port number.

public String getPort( );//returns the server port number.

public void setStatus(int i);//sets the device server status. (Enabled/Disabled)

public int getStatus( );//returns the device server status.

public void setCacheSize(int numBytes);//sets size of the cache in bytes.

public int getCacheSize( );//returns the cache revalidation time in seconds.

public void setCacheRevalidateInterval(int secs);//sets the time interval in seconds between which cache is revalidated.

public int getCacheRevalidateInterval( );//returns the time interval in seconds between which cache is revalidated.

public void setMetadataCacheState(boolean state);//sets the state (true/false) for whether metadata cache is on (true) or off (false).

public boolean getMetadataCacheState(boolean state);//returns the state (true/false) for whether metadata cache is turned on.

public void setUpdatePackageCacbeState(boolean state);//turn on (true) or off (false) update package cache.

public void getUpdatePackageCacheState(boolean state);//returns the state (true/false) for whether update package cache is turned on (true) or off (false).

An UpdateStoreMBean interface may be implemented by the UpdateStore object to expose interfaces that a SNMP management console can use to query or set configuration parameters.

public void setName(String name);//sets the update store name.

public String getName( );//returns update store name.

public void setHost(InetAddress ip);//sets the update store host location.

public InetAddress getHost( );//returns the update store host location.

public void setPort(String portNumber);//sets the update store server port number.

public String getPort( );//returns the update store host location.

public void setStatus(int i);//sets the update store status. (Enabled/Disabled)

public int getStatus( );//returns the update store status.

The table below shows exemplary alarm notification types that may be defined in the MIB.

| Notification | Description |
|---|---|
| SystemExceptions | Exceptions generated by runtime |
| | system. |
| updateStoreDisabled | Update Store disabled event. |
| deviceServerDisabled | Device Server disabled event. |
| updatePackageNotFound | Device Server query resulting in no |
| | package found event. |
| updatePackageDownloadFailed | Device Server transfer of update |
| | package to Device Agent failed event. |
| updateProcessFailed | Device Agent update process failed. |
| multipleDownloadAttempts | Multiple retries for update package |
| | download event. |
| licenseLimitExceeded | License transaction limit exceeded |
| | event. |

Access control values (read, write) for each folder (manufacturer, carrier, device model) may be specified for each role in the system. This indicates that there may be a many-to-many relationship between folder and role. To demonstrate that relationship, an AccessControl table with columns folder_FK (folder foreign key), folderType (manufacturer, carrier or device model), permission (read or write) and role_FK (role foreign key) may be defined. Each role may specify the permission for each folder for each role.

The controller components consist of action Servlet classes, which may be responsible for processing a request from the client and forwarding a view (JSP page) as a response. These classes may take care of the interaction logic between the user and the web pages.

| Action Classes | Description |
|---|---|
| LoginAction | Authenticates a username and password |
| | combination. |
| DisplayUpdateStoreAction | Forwards to either DisplayCarriers- |
| | Action or DisplayManufacturersAction |
| | based on whether it is a US/Japan or |
| | European model. |
| DisplayCarriersAction | Puts list of sorted Carrier objects in |
| | context. |
| DisplayManufacturersAction | Puts list of sorted Manufacturer objects |
| | in context. |
| DisplayDevicesAction | Puts list of sorted Device objects in |
| | context. |
| DisplayUpdatePackagesAction | Puts list of sorted update package |
| | objects in context. |
| DeleteCarrierAction | Deletes one or more Carrier objects. |
| DeleteManufacturerAction | Deletes one or more Manufacturer |
| | objects. |
| DeleteUpdatePackageAction | Deletes one or more Update Package |
| | objects. |
| AddCarrierAction | Adds a new Carrier. |
| AddManufacturerAction | Adds a new Manufacturer. |
| AddDeviceAction | Adds a new Device. |
| AddUpdatePackageAction | Adds a new Update Package. |
| ReplaceUpdatePackageAction | Replaces an existing Update Package. |
| EditCarrierAction | Edits a Carrier. |
| EditManufacturerAction | Edits a Manufacturer |
| EditClientDeviceAction | Edits a ClientDevice. |
| EditUpdatePackageAction | Edits an update package. |
| SearchUpdatePackageAction | Searches the store for update packages. |
| StateChangeAction | Schedules state change for update |
| | package. |
| NewAdministratorAction | Creates new administrator account. |
| NewRoleAction | Creates new role. |
| DeleteAdministratorAction | Deletes administrator. |
| DeleteRoleAction | Deletes role. |
| EditRoleAction | Edits role. |
| EditAdministratorAction | Edits administrator |
| DisplayServersAction | Puts Device Servers and Update Store |
| | in context. |
| ProvisionDeviceServerAction | Provision a new Device Server. |
| ToggleServerAction | Enable/Disable servers. |
| ConfigureDeviceServerAction | Updates configuration of Device Server. |
| ConfigureGeneralAction | Updates general configure of the |
| | mProve system. (for e.g. time zone). |
| LicenseKeyAction | Updates license key. |
| DisplayAlarmsAction | Puts list of sorted alarms in context. |
| ChangeAlarmStatusAction | Change alarm status. |
| DisplayActivityLogAction | Puts list of sorted activities in context. |
| ExportActivityLogAction | Exports list of activities to an XML |
| | string. |

The combination of JSP pages, Servlets and JavaBeans may deliver a web-based HTML management interface console. The use of the MVC design pattern ensures that any changes or customization of the JSP pages, which may be required for certain customers, may be done independently from the rest of the system.

FIG. 7 illustrates an exemplary Update Package Store GUI structure, in accordance with an embodiment of the present invention. The difference between views of the update store lies in whether the manufacturer or the carrier may be at the root of the update store tree. The DisplayUpdateStoreAction Servlet may be responsible for returning a view based on a property value that states the update store model, for example, US/Japan view or European view. The Servlet may check a property value and may forward control to either the DisplayCarriersAction or DisplayManufacturerAction Servlet that will instantiate the appropriate objects (Carrier or Manufacturer) and put them into a page context. The updPkgExplorer.jsp page may then render the page with the necessary information from the objects. The specification of the model (US/Japan or European) may be specified in a properties file.

The updPkgExplorer.jsp page may be similar to a simplified ‘Explorer’ application on a Windows operation system. The updPkgExplorer.jsp page may render a list of folders or folder contents on the page. Clicking a folder may open up a list of the folder contents. Clicking on a content item (Update Package) may reveal detailed information about the content. A navigational guide may enable the user to go to different points in the update store.

FIG. 8 illustrates an exemplary method of addition of a new carrier, in accordance with an embodiment of the present invention. The addCarrier.jsp page may provide a form for the administrator to fill in the required parameters of a new Carrier. The form may be submitted to the AddNewCarrierAction Servlet, which may validate the form data and may create a new Carrier object that will be persisted to the database. The Servlet may then respond with the updPkgExplorer.jsp page that may display the new list of carriers.

FIG. 9 illustrates an exemplary method of deletion of existing carriers, in accordance with an embodiment of the present invention. The delCarrier.jsp may display the confirmation page with detailed information about the carrier to be deleted. The delete confirmation may be submitted to the DeleteCarrierAction Servlet, which may retrieve the appropriate Carrier from the database, may change the status of the Carrier to ‘Deleted’ and may persist the information to the database. The Servlet may then respond with the updPkgExplorer.jsp page that displays the new list of carriers.

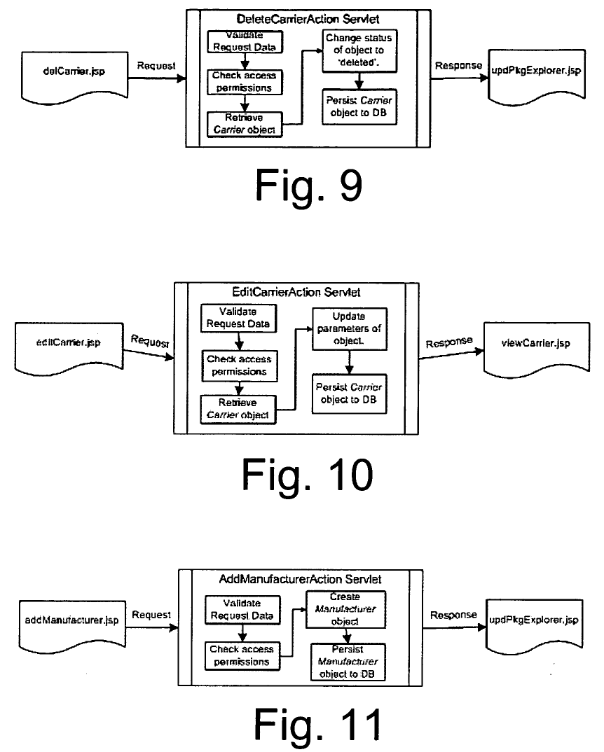

FIG. 10 illustrates an exemplary method of editing existing carriers, in accordance with an embodiment of the present invention. The editCarrier.jsp may display editable parameters of the carrier in a form. The administrator may make the necessary changes. The form may be submitted to the EditCarrierAction Servlet, which may retrieve the appropriate Carrier from the database, may update the parameters of the Carrier, and may persist the information to the database. The Servlet may then respond with the updPkgExplorer.jsp page that displays the new list of carriers.

FIG. 11 illustrates an exemplary method of addition of a new device manufacturer, in accordance with an embodiment of the present invention. The addManufacturer.jsp page may provide a form for the administrator to fill in the required parameters of a new Manufacturer. The form may then be submitted to the AddManufacturerAction Servlet, which may validate the form data and may create a new Manufacturer object that will be persisted to the database. The Servlet may then respond with the updPkgExplorer.jsp page that displays the new list of manufacturers.

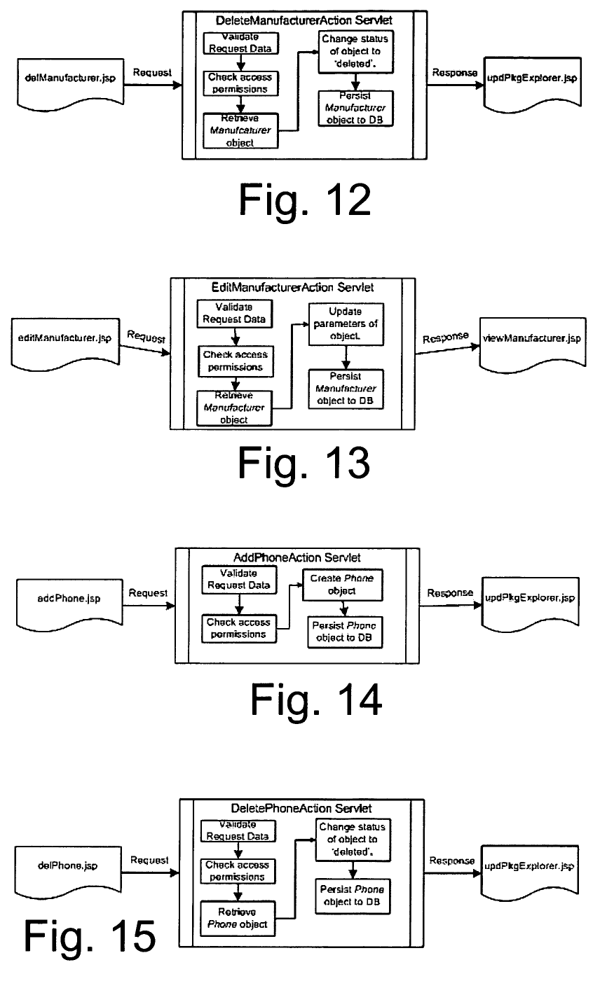

FIG. 12 illustrates an exemplary method for deletion of existing device manufacturer, in accordance with an embodiment of the present invention. The delManufacturer.jsp may display the confirmation page with detailed information about the carrier to be deleted. The delete confirmation may be submitted to the DeleteManufacturerAction Servlet, which may retrieve the appropriate Manufacturer from the database, change the status of the Manufacturer to ‘Deleted,’ and persist the information to the database. The Servlet may then respond with the updPkgExplorer.jsp page that displays the new list of manufacturers.

FIG. 13 illustrates an exemplary method for editing of existing device manufacturer, in accordance with an embodiment of the present invention. The editManufacturer.jsp may display editable parameters of the carrier in a form. The administrator may make the necessary changes and the form will be submitted to the EditManufacturerAction Servlet, which may retrieve the appropriate Manufacturer from the database, update the parameters of the Manufacturer and persist the information to the database. The Servlet may then respond with the viewManufacturer.jsp page that displays the new manufacturer information.

FIG. 14 illustrates an exemplary method for addition of a new client device model, in accordance with an embodiment of the present invention. The addClientDevice.jsp page may provide a form for the administrator to fill in the required parameters of a new ClientDevice. The form may be submitted to the AddClientDeviceAction Servlet, which may validate the form data and create a new ClientDevice object that will be persisted to the database. The Servlet may then respond with the updPkgExplorer.jsp page that displays the new list of ClientDevice models.

FIG. 15 illustrates an exemplary method for deletion of existing client device model, in accordance with an embodiment of the present invention. The delClientDevice.jsp may display the confirmation page with detailed information about the carrier to be deleted. The delete confirmation may be submitted to the DeleteClientDeviceAction Servlet, which may retrieve the appropriate ClientDevice from the database, change the status of the ClientDevice to ‘Deleted,’ and persist the information to the database. The Servlet may then respond with the updPkgExplorer.jsp page that displays the new list of ClientDevice models.

FIG. 16 illustrates an exemplary method for editing of existing client device model, in accordance with an embodiment of the present invention. The editClientDevice.jsp may display editable parameters of the carrier in a form. The administrator may make the necessary changes and the form may be submitted to the EditClientDeviceAction Servlet, which may retrieve the appropriate ClientDevice from the database, update the parameters of the ClientDevice and persist the information to the database. The Servlet may then respond with the viewClientDevice.jsp page that displays the update ClientDevice model information.

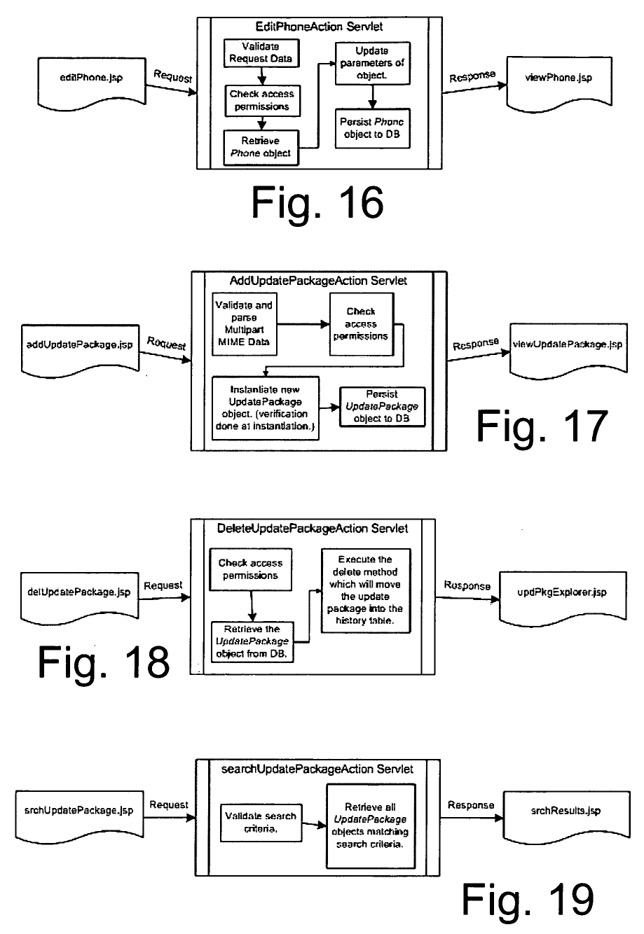

FIG. 17 illustrates an exemplary method for uploading of an update package, in accordance with an embodiment of the present invention. The addUpdatePackage.jsp page may provide a form for the administrator to fill in the required parameters of a new UpdatePackage. The form may be submitted to the AddUpdatePackageAction Servlet, which may validate the form data, check for uniqueness and create a new UpdatePackage object that will be persisted to the database. The Servlet may then respond with the viewUpdatePackage.jsp page that displays the new update package information. Multiple uploads of update packages may be supported via a page that has multiple forms.

The AddUpdatePackageAction Servlet may instantiate a new UpdatePackage object that may do the proper verification when the update package binary image is passed in via a method call.

FIG. 18 illustrates an exemplary method for deletion of an update package, in accordance with an embodiment of the present invention. The delUpdatePackage.jsp page may display information about the target update package to be deleted and confirm the deletion. The request may be handled by the DeleteUpdatePackageAction Servlet, which may move the update package into a history table for archive, and respond with the updPkgExplorer.jsp page, which may display the new list of update packages.

FIG. 19 illustrates an exemplary method for searching for an update package, in accordance with an embodiment of the present invention. The srchUpdatePackage.jsp page may display a search form used for specifying the search criteria, which may be a combination of ClientDevice model, manufacturer and/or version numbers (source and/or target). The SearchUpdatePackageAction Servlet may parse the search criteria and retrieve all UpdatePackage objects satisfing the search criteria, and respond with a srchResults.jsp page listing the found update packages.

The UpdatePackage object representing the update package may record each upload, download, deletion, and edit action to an update package.

The statistics for the total number of downloads and date/time of last download for each update package may be recorded by each UpdatePackage object. For the number of subscribers requiring multiple retries, mining the activity log may retrieve those statistics. The attributes of an update package may be encapsulated in an UpdatePackage object.

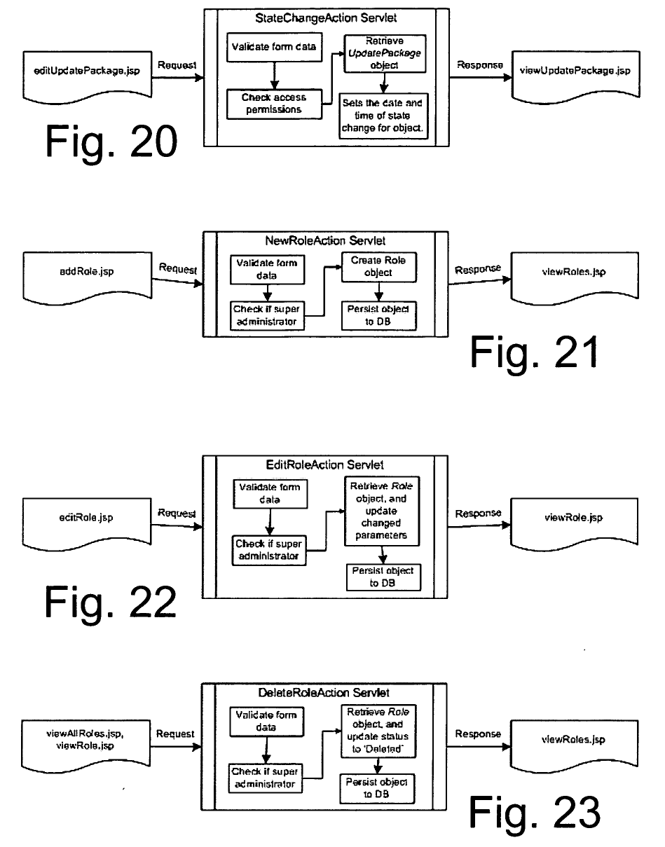

FIG. 20 illustrates an exemplary method of changing an update package state, in accordance with an embodiment of the present invention. The editUpdatePackage.jsp may display the editable fields of an update package. For state change, the administrator may change the state value and specify a date/time for the change to happen. The request may be made to the StateChangeAction Servlet, which may retrieve the appropriate UpdatePackage object and update the date/time and the target state change value. The actual state change may be done the next time the UpdatePackage object is called (for download, edit, view etc.).

The appropriate Servlets doing add/edit/deletes of Carrier, Manufacturer, ClientDevice or UpdatePackage may consult with the Role object to determine permissions before further processing. Another approach may be to disable any user interface elements (e.g. buttons) that perform functions, which may not be allowed with a particular administrator.

The values for initial super administrator username and password may be specified either in a properties file or asked by the installation process.

Administrator account parameters may be encapsulated in the Administrator object. The Role object may encapsulate administrator roles.

FIG. 21 illustrates an exemplary method of creating new roles, in accordance with an embodiment of the present invention. The addRole.jsp page allows the super administrator to fill in the required parameters for a new role. That page may have a checkbox matrix of folders against permissions (R,W). The default permissions may be both R and W checked for all folders. The NewRoleAction Servlet may process the form request and create a new Role in the database.

FIG. 22 illustrates an exemplary method of editing existing roles, in accordance with an embodiment of the present invention. The editRole.jsp page may allow the super administrator to change parameters of a particular Role. The EditRoleAction Servlet may process the request and persist the Role to the database.

FIG. 23 illustrates an exemplary method for deletion of an existing role, in accordance with an embodiment of the present invention. The viewAllRoles.jsp or viewRole.jsp may send a request for deletion of a particular role to the DeleteRoleAction Servlet. The Servlet may check that no Administrator is holding that Role and if so, mark the Role as ‘deleted’ and persist the object to the database.

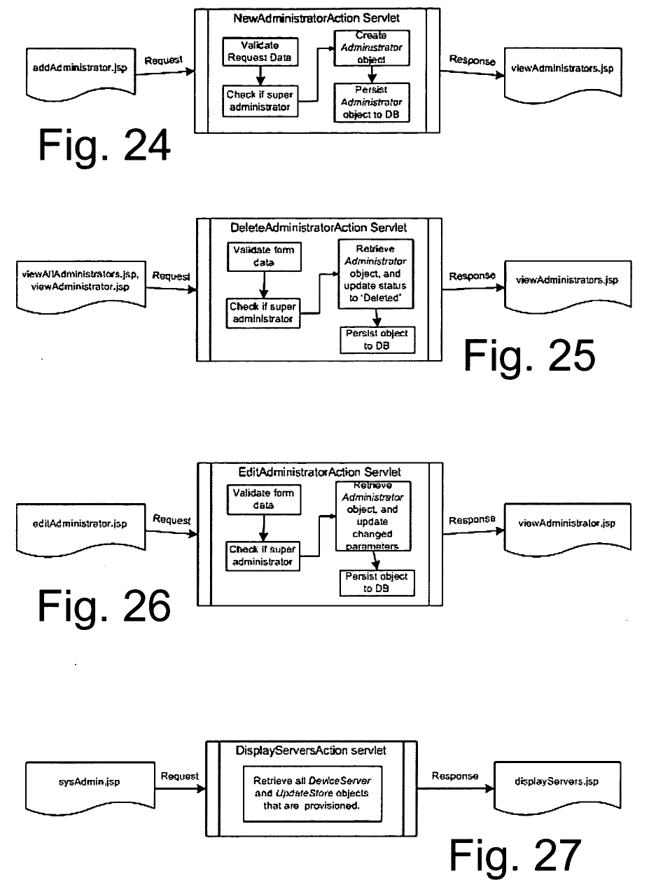

FIG. 24 illustrates an exemplary method for creation of a new administrator account, in accordance with an embodiment of the present invention. The addAdministrator.jsp page may provide a form for the super administrator to fill in the required parameters of an Administrator. The request may be handled by the NewAdministratorAction Servlet, which may check for uniqueness and create a new Administrator object and persist it to the database.

FIG. 25 illustrates an exemplary method for deletion of an existing administrator account, in accordance with an embodiment of the present invention. The viewAllAdministrators.jsp or viewAdministrator.jsp may send a request for deletion of a particular role to the DeleteAdministratorAction Servlet. The Servlet may mark the Administrator as ‘deleted’ and persist the object to the database.

FIG. 26 illustrates an exemplary method for modification to an existing administrator account, in accordance with an embodiment of the present invention. The editAdministrator.jsp page may allow the super administrator to see and edit the parameters of an Administrator. The EditAdministratorAction Servlet may process the request and persist the modified Administrator object back to the database.

FIG. 27 illustrates an exemplary method for display of a provisioned device server(s), in accordance with an embodiment of the present invention. The DisplayServersAction Servlet may be responsible for retrieving all provisioned servers, including Device Servers and the Update Store and placing it in a page context to be retrieved by the displayServers.jsp page.

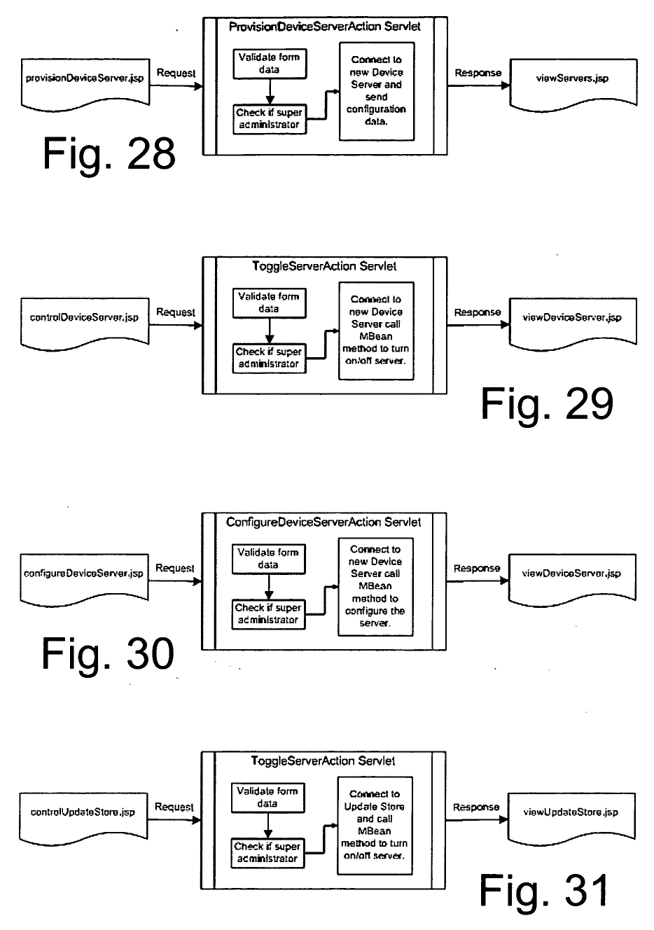

FIG. 28 illustrates an exemplary method for provisioning of new device servers, in accordance with an embodiment of the present invention. The provisionDeviceServer.jsp page may provide a form for the super administrator to fill in the required parameters of a new DeviceServer. The request may be handled by the ProvisionDeviceServerAction Servlet, which may try to connect to the Device Server via the DeviceServerMBean and pass to it configuration information. A Device Server, which has been connected and passed the configuration data, is considered ‘provisioned.’

FIG. 29 illustrates an exemplary method for enabling/disabling device servers, in accordance with an embodiment of the present invention. The controlDeviceServer.jsp page may display a confirmation for enabling or disabling a device server. The request may be sent to the ToggleServerAction Servlet, which may call a method in the DeviceServerMBean object to enable/disable the device server.

FIG. 30 illustrates an exemplary method for configuring of device servers, in accordance with an embodiment of the present invention. The configureDeviceServer.jsp page may allow a super administrator to change the configuration parameters of a provisioned Device Server. The ConfigureDeviceServerAction Servlet may handle the request and call a method within DeviceServerMBean to update the configuration parameters.

FIG. 31 illustrates an exemplary method for enabling/disabling of update store, in accordance with an embodiment of the present invention. The controlUpdateStore.jsp page may display a confirmation for enabling or disabling a device server. The request may be sent to the ToggleServereAction Servlet, which may call a method in the UpdateStoreMBean object to enable/disable the device server.

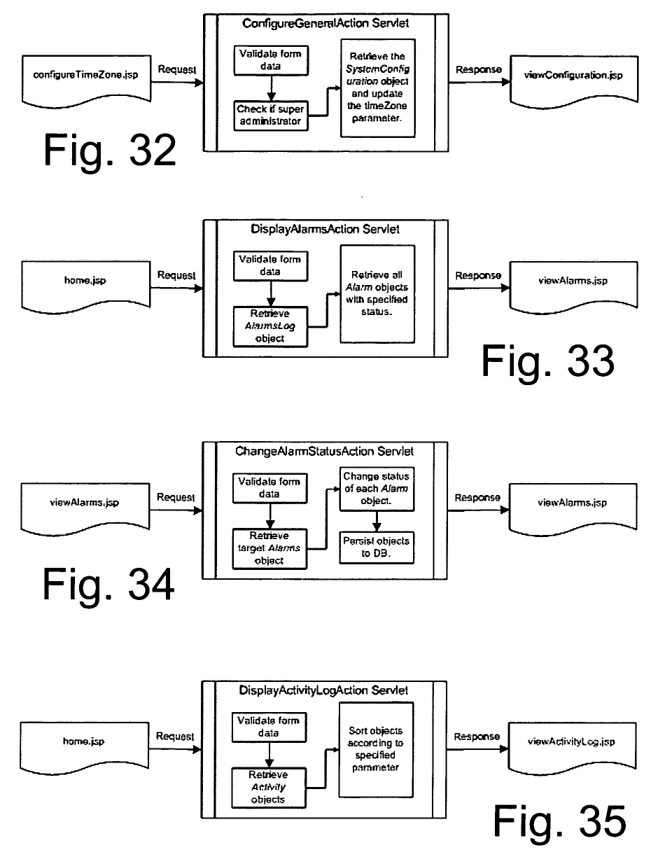

FIG. 32 illustrates an exemplary method for time zone configuration in the system, in accordance with an embodiment of the present invention. The configureTimeZone.jsp page may allow the super administrator to select from a fixed list of time zones. The request may be sent to the ConfigureGeneralAction Servlet, which may change the time zone parameter using the SystemConfiguration object.

SNMP notifications may be sent via the notification mechanism of the MBeans existing at the Update Store and the Device Servers. The alarms log features and functionality may be encapsulated in the AlarmsLog object. The alarm severity levels may be encapsulated in the Alarm object. The alarm parameters may be encapsulated in the Alarm object.

FIG. 33 illustrates an exemplary method for display of active, acknowledged, and all alarms, in accordance with an embodiment of the present invention. The DisplayAlarmsAction Servlet may take a request that specifies an alarm status and it may retrieve all Alarm objects with that status, to be displayed by the viewAlarms.jsp page.

FIG. 34 illustrates an exemplary method for change of alarm status, in accordance with an embodiment of the present invention. The ChangeAlarmStatusAction Servlet may handle the request with a list of alarm indices and the status to be changed to, and it may retrieve the target Alarm objects, change the status and save them to the database.

If a process may remedy an alarm automatically, the process may retrieve the appropriate Alarm object and change its status. The list of alarm conditions may be captured and reported by the various components in the system.

FIG. 35 illustrates an exemplary method for displaying the activities logs, in accordance with an embodiment of the present invention. The DisplayActivityLogAction Servlet may be responsible for retrieving the list of Activity objects and sort them according to the requested parameter. Activity log entry parameters may be encapsulated in the Activity object.

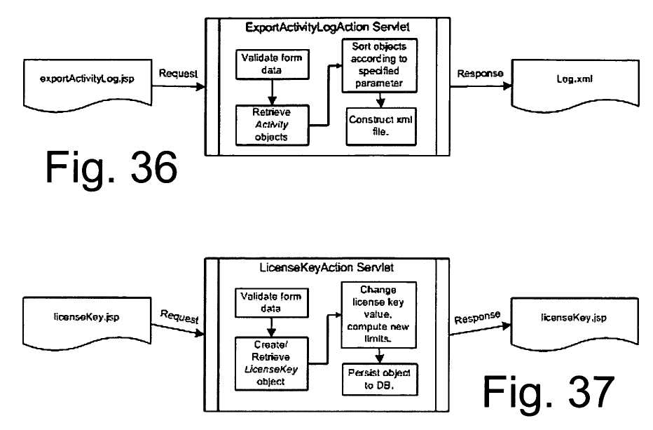

FIG. 36 illustrates an exemplary method for log retrieval for analysis, in accordance with an embodiment of the present invention. The exportActivityLog.jsp may allow the super administrator to specify which activities are wanted according to the parameters of an Activity object (e.g. timestamp, status etc.). The request may be processed by the ExportActivityLogAction Servlet, which may retrieve the targeted Activity objects, sort them and construct an XML file with these objects as entries. The XML schema of the export file may have meta-data related to the query, description, and for each activity entry, the schema will be similar to the attributes defined for an Activity object.

FIG. 37 illustrates an exemplary method for the LicenseKeyAction Servlet, in accordance with an embodiment of the present invention. The LicenseKeyAction Servlet may be responsible for processing any license key updates. The LicenseKeyAction Servlet may call the LicenseKey object to verify the new key and compute new limits for the deployment. The license key may be an encrypted string that contains information about the license agreement. For example, when decrypted, the system will be able to get transaction limit, host Internet protocols (IP's) allowed information from decrypted string.

The conditions and limits imposed by a certain license key may be computed based on the key value. Exceeding the limits may send an alarm notification to the Alarms log. Enforcement of the license may be also done via a manual audit of the activity log. The license key may be encrypted.

There may be a requirement to be able to configure the update store and device servers via the management console. This may mean enabling or disabling the update store or device servers. Other configuration parameters may become apparent during implementation.

The unique identifier for Carrier and Manufacturer created by the super administrator may need to be consistent with an identifier sent by the device agent, so that queries to the database return appropriate results.

The following is an exemplary update package catalog (UPC)

<?xml version=“1.0”?>
- <update-package-catalog>
<schema-version>1.0</schema-version>
<manufacturer>Bitfone</manufacturer>
<model>BF2000</model>
<carrier/>
- <update-package>
<description/>
<old-version>0.02.11</old-version>
<new-version>0.02.12</new-version>
<new-image-size>262144</new-image-size>
<validation use=“yes” />
<validation-region-start>0</validation-region-start>
<validation-region-size>0</validation-region-size>
<va1idation-region-CRC>942238887</validation-region-CRC>
<update-package-size>4620</update-package-size>
<update-package-CRC>3027207287</update-package-CRC>
<update-package-binary>
RFVQAAEAAABS6X9m/BEAAERVSQABAAAAtMJF7+kRAABQREMAAQAAAPzzUVNAAAA
ABQAAAAUAAAAA
AAEAAAAAAAAAAAAAAAAAkiQAAEtIHRh6AwAAdwAAABEAAADrDAAAuQcAAHEAAA
AJAAAAXxwAAEJE
QwABAAAAkK5kVIwAAAAAAAAAAAAAAAAAAAAAAAAAAAAAAJjY9T+Y2PU/AgABAA
EAAAAAAAAAAwAA
AAAAAADGHcXW0w51ewEAAAAGAAAAAAAAAAgAAAAFAAAAOvRilDr0YpQDAAEABw
AAAAAAAAALAAAA
BQAAAM3/Rytk+nksBAAAALgHAAAJAAAAcQAAAF8cAACnbCk4p2wpOFVEQwACAAAAEm
SZy+0QAAB4
2pVVzW7bOBC+9jH6CPsKE1qRFVdVVNVw1XSxKBZp0eNie+mhANNzH0wUTTM0KyuK4/ot9r
zf0Ipr
q0aBQhj+zJDD+f1m9OWG5OjmC0baEb5Ikjy7KTTZPUlSiSpXZHDGkI6bnlpQl+hECis0zthEi/W1
Eoo6uqfVxNAWNzoeI510IM9UunJJ95CuIekwsrQ9kFryqS+6or2yPL5+Qp50Zkk/fzqPNB61jlS0
J77mcH3Vn3k/1Ay+108rTJIPpexzU6xerc7rUZvsHrQ0p++QK8jWiIKF1ezd1u0PcZG7791u1jG0
DMbuJBeni/Ver4Sv9ljvn73m39LJRtkZnYyM2VX+pIj70CDvJTtgcySyc0g+DrgAS+QzISSc0GO
hhIndKZoefKw9jv/J5pkYj74zPSoGtDkcS372dHjyeZyfqDZhLfaX5A83jOq91g+Rfr18scu/SM+
fepXGpof85CTKmFob/PU7LTPfL/v58d93OaOWuJKUUKH0fAYrUmXNsWKAjeyPMbMdaT+Ahb
CC44p
VVxLYd0WNS3zNWOoeKB5Ya5akqnjPAsb4mRFQFQ4jcq81jM+bQLXRqzHxuAW/toIYIQcE9mZ
Sjoh
8yb21AU7g1XAnZpVwXremzC3zE/UtP6MivqoaAHczemWarp7VpEpa/rGFVBwZBRwhpsp+4Jq+eT
3
muUJrarnPNDd37AKbcP1ftvEBQ2+6Cs7ttnP91fnqKQ3VQaEo4oY//oo5vbK1ODsLNh5KWy4bUv9
litPlTJ0tuNc2bI54Nme53O2ySfu65YaZMifS2S1ie6eLxEPKfSLxRSRBb59LCMLX7qkoScmXYzq
M9k3DCkaiBRt0MKR+Ly+MJMKqyqpaYNAcstyaUNOmHE1rkQ9grK4mXjRIiQ+NuN6XIuOZLZh
PRkS
cFEhJZKqmPc6UhTSEKkMY64QRDhIDBb5QtEt7msYb0Q1Wl4gRRmXqQ9NTP3r4g3ONdgBsInH
qqEN
2teGZKxnM1dTDXDD18JED2g+cyRhG5Ir39W07RN0QPBP963J7KHgkp+5IXklbAd0TulZPBvewJy
7
aA8wIcvDOwDXNMApacOPwAv20aO5Arjj72HF5ReKKFe5BRTU21uqLucoKRXbr2jIJP8BQBjS1J
0t
RSfMBD/bzILTijAm0CYqaGbAIMoZF9SCKkT6v/8BkT0VWHjaY2Bg3HSq+ZgJAwPjFlnP27zhs71
v s3MyxyuqRavrKSpbm3NwcCiq6ioqKro5Oi50ctTQUTAGcmbPcHTMUAfjKyrrKoeGcivamutqKisq
pho6K9iqcig7qjvqausralir6PrHKypqGzioaioXaypqAQD5IxjaeNozOcXMwMDI+JIZAAoeAfB4
2o1Ze3CU1RWfL9ndfJsXJApsSJATIHF5o/KI1aHLY/QLCKQiF1CU4ita0Y+Hujyi4VFdo5YVHQ34
d1oN4JRUJ5YqtdGxGmv/2IB2OortWkeY+kfd1LaE8Eh/595z9/s2wkwzfHvu+Z1zz73fOfeec+9H
Q1NPSe/pvd8k3/vkklPxnqfnF5+ieMyOUV297c5wKD6j315HpLGJwCYAm+DDqoERMPJhQ4ENAT
ZE
Y5Rw+6nLReP9ErK68AwtImt1iPJfRBuP+otfKBZGCD1PqK2o6UNjKQUUjaj6R2Qng62qFU6GWg
Ut
GzwFKqX5ydJddgENshWXJ5wFCjP8D3+1VBNAt2hKT4OSexwM+goP2gruWeZ2Ge5x5n5uuAcd/b
7b
8b7b0N5mBJtFsBGCDWhvEIEZbEx2sB+wwRmm3yTmxhtuNHNkuIhzFueyoEQERRAUo11oBsu6u
L1D
AnMtVJZAZY1yqYLmA5oHaJ4HzQIUY6MMTba6i3tqekU0HaJpEE3ztDFddxygcR6UsyZgoKjn636
O
ZHmW/2N/NrKK7+jXwaX4ce4L+q3Qo4oqs1+imYbZtDfSnwF9CuhTD/oToI8BfexB7wLqBNTpQb8
B
9CagNz3oNUD7AO3zoJcBvQToJQ96GtBTgJ7yoMcAPQroUQ/aCmgLoC0eFAd0H6D7POguQKsBr
fag
mwCtArTKg5YBWgpoqQctBLQA0AIPmgtoDqA5HnQpoDpAdR40GRAWWXxS1vN0RkQ1EI2BaI
ynPRxQ
BaAKDxoMaBCgQR4UBBQAFABkp4ki2KguVp7Z5KJ2CGrdUOv2en4I6ANAH3jQ7wAdBHTQg9
4A9Dqg
1z2oDdCrgF71oOcBPQfoOQ96AtBOQDs96GFACUAJD7ofUBOgJg9aD2gdoHUedDugRkCNHnQjo
BsA
3eBB1wBaDGixB2FfufWA6j3oh4BmAprpQdhP71RAU7NxWSx5GNvKHQvJWE8Z28odCWikByF
XuuWO
7DANYXO5BYAKdBo10ciUmCwNXbcMCmXn6mO6JDt6HWqi6Lru4w5tIsqMjmASVEC0oSEa/ux
rhzOZ
c/MXjs7jbOgjGOqCoS7P9tuA3gL01q9QtAPbD2y/FApKz/07+f7K0py+MrpKZKvGnbda1kHwnXje
19Uj/h+xEP+HafzVNA7JgB8a4KBptJvGL31zQnZ3H8OcHjvXbtYYtrF7L7B7zdSzfwMLnG+6eq63
mGGXmcZC05gtI8wwwATTINP4v4vq9wplQTKgC6WpmFwoy6Q0lkhpLMktjfkDS6N6eew79xXH
VyWf
E8EzEOxGe7cR7BRBEoIdaO8wgoe4uG33FczcKpk/sEp+/1AiBVMJ4CZ3vJNbO79fiqSM+mpnKXN
F
ZlziUPncSGqPqjI0TehErxzhvOLWwnStt1BwdHGrAFWZYJVJIychassvS6jhqijVMn5QRkKLWMt0m
+AMaV91IATeJwirpsEzhTfhnRfO6KfPViWB6Ee9FZ17ZNVT9IjVHZrn/PkZ0eX3X1m1qk1qZxCm1
qAoLD1uZO7iNpFPYs/OETLUMUx0s0z0PtBzPMDzN4CuK9PpCYm8ODA5QfnPHk2xVn4tMVE08
Qe8W
erOm6aZ0dumblR+fK3Sc0JHGg7mnQPLnASX/r3jhn0K/Nu76QjoeFto19B2hbwjdI/R5oU8K3Thg
9rJr48s1RYd7jp5hvkHwK4ReJvQiobVGZU2YJSE5Vnmbcqq1fgm185nQVHbM7/52uqCqi1ftH0T2
t1BJZnpPgj4j9HGhDwndLHSt0NuErhB6tVBH6Eyh15iIDHyh8pwXy1YNzjxNOuGt8Q81gV+j4hS1
YfmhhJwKVK1wjFtBF2V1vjmpdMpYa0BmVPK3Thob3rKhrPSRnN71Z71L5J/peMjRk0zex5NYL5k
A
fZI/ZaDRB9zAwHUCaLvJ+ZJmUN1dxxGnQZy+Ox3uea2Pkj/kTpebBJO8hNkpwlYqs7UMjc5GYrjc
Oct5q9Wf9+01x4/q/eDbE8rdpZIogopKCQ9UwRsStrWysdZK2gpjENtR3lnrvzc0d4xzOltYudpT
Hgb1oVAeKnYGnBvWyiZtW29Z54ubv+vY0v6OdrQqSsEqq60Zs9kXcXWDp7YnHLfncHOripEK2z
2q
WRGaotnGLKu8pIbGunGXOZJQ1BZp7OXIW9X1oWyq5vMypUvSV0HxK1kKs7xh1K1Lh8Ms70rf
EBH0
Hoaew2QIu+erfh4iWP1RMDtEMZSKHCkmpA7Fj0h8B1QV61QHn4Oo6STRxmbbPvQGZ88NsbB9
qE11
58z4PkImt9Aa2hdMM1Leh2q9FCMvwsWpVWXu0sOU+fYERQu7N6HXxrxoAZdLLmp3OqY6MH
ezY2qE
Wj719bFILE7Rgu48+i1dMa/hGqv6AK+4uax3qejpe+kUY+NiR9/PtSzKXKXIKLY8FJpe2o7rt1gO
dVvV7RRC8QFoJYcEVdWY4FpWEtQ44cAqy4KHs0VksFSZhuAQiuDJ4M5KNRSgYjt6XoppODpI
0uc0
SNEgvzFoYTRf0aLoyO4X1Q7YT3f3wnh913ouf7IgeQLUEXE6N1M03M3xVLrWdsjsLwNY7HRh
mNHp
cKrVDVHfsQPj4PZQyuJDkxXk4JxEHT1xTFkkuWqTRo7jqZQSmefEmtwrkdy0pgV+s5/PdLzXz1FK
3ubouqjdvFIyjIQqWe/oyqijdPtPR1UXrTnd0jdGy8czVmJAkRzA73KgOdXTZEbPjjnEcTHX3+9yq
Lpz3+HpxGL/fINkroZzUro9Mrvfi5mSgZb7040oy4cFOwb+YDB9A4hebeasPHmPNREc5uvJrWaWj
s5RZZqTSW9+x8iLPKL+JmT0vt1+oi0p+6mWOFa+R3cGkOgMnH3X02SqbzpsZaPIB6xhw/fk9eatk
YY7QTY46erE0yi6psnvmIsEvFxXczt0fO3pz8oaYUoX+89jk1b4xTAyzwEUMTMoZ9FxHVzVk541z
fwnKjhvAy793NPewxEkor4pMQviJbw5LGVjiA65ioD5nUjNITJQy9zLHe4fcisaaFzIwxgcMZ2BY
jrVisYb94/KeC5vqFsV6qj3mX21SUs43gN5GW9pDfBXdtxQrLOIiGSesdpbw9mxAVrHq7ZXMUy1v
Pmo0mw+83vW76o1G0U69SvATGFNMrdtn531Bz7I8pfCSZF5rjDorgi1MaWddFWXuOUnRQIp2J0f
m BcqLecrBVDzB1E7FVyNVX3xS5fByraftJ+sSFI4eJnphrrklgskM61Wqy/sU+dWJ8nQjRpvVwr+k
Wg2qFZ2f6h0xdgrfvZW96r31CW11k7rGLUrV7eBCMKxNyS1h77KHY8KJAk0DpMwkw3uvRr801dr
w
9WfBtN1q1bEQdqMLU+jNVhMaM30ToawN5M0Uu+CjXv1qmTd5/rge+metmit1k2hiZFLLAtDpkW
1b
y9MLFL8Eeb15iRJObFmoybWMLdB6UaWnsImR1Vq0RCzhd6uosVkd0+jg7gMP+0dusYdLcDorrB
aO
D1P4iLK+6KyItegXRbJP9ddQem/N7Z1X+iU6cLKVtFTwAy2ax1qoMhiYWNyX4IXQf7zvTO5CkHV
g
1gNpH40vxI3sk175MjI6Mkesc1qK42CxLoSDhL020KbOqGvyEcFWPoZZbfpAHeRdEcAqHozk2Y19
nMLTrg961C58Z0jXUVIsxzA/Gj7CNYFbhUcu0Je+xnuH0Eo86/EMzSOa8OsATf0L0aU2UWP7LEq
t
3Mb5gXNn/AWThZ9hrtVk6J3M7TDcw8w9aLj7mduk+6GAFvQ8gNcOhiaWu1UqA7ssX220b3X0V
VZz
18shRXOLHX2v0p1ffZ7g+6vP1uVyWPEdTyYbLuqvhcmRjj7zam6Ioy8DmjtLGtJDqmom3zGht597
vWY8woc0/mKkbbzA3LOGe4q5Jwz3CHOJrEdCPZX95n0a9XuY7x5afw1zdxmu0dG3Ts3dyNz1Az2
U
tbyP76J1yIbJOSyKGUXz/wuuPjWq9Dzwc6/WvMB/qhvgqEJHZ215QVQU5XgonzqyH/70sUCXavX
T Tel/HWsTzsrUhmI+SgdxSyjG6v59B65bowD0H991msbc4tAKV311RC/dKiusnjUHB/0VxP+fExkg
+JFUJGrtW9psTYW1FbFQrHTLbJ7EtzyJgUZZmZQyDiIrM11z43LM4Z7SzCWmIRr6nGnN/M4IY6E
0 c02jKy3No1jfob6WAb1gfutsUtpVaFUeobZYwooO+5zza3TQ51abOT0dEQ/cibrI9CDoVGxIu4My
1/XyFUndY8P2YfpZnyosvZSZ1xWUjG5FSplclCrRX19psvrlG1C7fTCGslf97vERp6k6REszc87Q
5Pxu5eX3+5FV6cswHeJo6A+6uc2R9c4SFT+VO/Z4wS1aw0utMhsjIWjA1Ska1RDCr3b4/wDVA0e3
////<update-package-binary>
<update-package>
<update-package-catalog>

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope., Therefore, it is intended that the present invention not be limited to the particular embodiment disclosed, but that the present invention will include all embodiments falling within the scope of the appended claims.

What is claimed is:

1. A system that facilitates updating of firmware in an electronic device, wherein the system supports lifecycle management of firmware updating information, the system comprising:
an electronic device comprising:
firmware;
loading software that retrieves updating information for the firmware; and
updating software that applies the retrieved updating information to the firmware in the electronic device.

2. The system according to claim 1 wherein the system further comprises a network that distributes the updating information to the electronic device, the network comprising:
updating storage that stores updating information to be distributed to the electronic device; and
at least one server that retrieves the updating information from the updating storage.

3. The system according to claim 2 wherein the at least one server distributes the retrieved updating information to the electronic device.

4. The system according to claim 2 wherein the at least one server further supports management of the lifecycle of the updating information.

5. The system according to claim 4 wherein the at least one server further supports management of the lifecycle of the electronic device.

6. The system according to claim 2 wherein the electronic device sends requests for updating information.

7. The system according to claim 6 wherein the requests comprise information about the electronic device.

8. The system according to claim 6 wherein the at least one server receives and processes the requests, and retrieves appropriate updating information from the updating storage based on the requests.

9. The system according to claim 2 wherein the network further comprises:
a first structure that manages the lifecycle of the electronic device; and
a second structure that manages the lifecycle of the updating information associated with the electronic device.

10. The system according to claim 9 wherein the first structure performs at least one of:
tracking changes of firmware versions in the electronic device;
providing information about available firmware updates to the electronic device; and
interacting with the at least one server to provide information about firmware updates.

11. The system according to claim 9 wherein the second structure performs at least one of:
supporting import updating information from an updating information file containing updating information for different version changes of firmware; and
verifying the authenticity of firmware updating information.

12. A method for updating firmware in an electronic device of a system, wherein the system comprises the electronic device and a network, the method comprising:
generating updating information in a generation environment;
saving the generated updating information in a storage;
communicating the saved updating information to a distribution environment; and
managing the lifecycle of the updating information.

13. The method according to claim 12 wherein the method further comprises packaging the saved updating information before communicating it to the distribution environment.

14. The method according to claim 12 wherein the distribution environment comprises an updating storage and a server.

15. The method according to claim 12 wherein the method further comprises:
receiving requests for updating information;
facilitating downloads of the requested updating information;
verifying reception of the downloaded updating information; and
utilizing the downloaded updating information to update firmware in the electronic device.

16. A system that facilitates updating of at least one of firmware and software in electronic devices, wherein the system supports lifecycle management of firmware updating information, the system comprising:
a network that distributes the updating information to electronic devices, the network having a lifecycle management component that manages the lifecycle of the updating information.

17. The system according to claim 16 wherein the network further comprises a management console employed for lifecycle management of the updating information.

18. The system according to claim 16 wherein lifecycle management comprises at least one of:
facilitating loading of the updating information;
facilitating deleting of the updating information; and
facilitating editing of status information of the updating information.

19. The system according to claim 16 wherein the network further comprises a lifecycle management component that manages the lifecycle of the electronic devices.

20. The system according to claim 19 wherein the network further comprises a management console employed for lifecycle management of the electronic devices.

21. The system according to claim 19 wherein lifecycle management of the electronic devices comprises at least one of:
provisioning of the electronic devices;
determining change of ownership of the electronic devices;
determining change of subscription of the electronic devices; and
determining when an electronic device is no longer in use in the system.

22. The system according to claim 16 wherein the electronic devices maintain statistics information regarding the total number of distributed updating information and the time of distribution of the updating information and communicate the statistics information to a server.

23. The system according to claim 22 wherein the lifecycle management component records the total number of distributed updating information and the time of distribution of the updating information for each distributed updating information to the electronic devices.

24. A configurable lifecycle management system for updating information that updates at least one of firmware and software in electronic devices, wherein the configurable lifecycle management system is capable of changing the state of updating information stored in a network that communicates updating information to the electronic devices.

25. The configurable lifecycle management system according to claim 24 wherein only an administrator is capable of changing the state of the stored updating information and specifying a time for the change of the state of the stored updating information to occur.
